(19) United States
(12) Patent Application Publication
(10) Pub. No.: US 2019/0143389 A1
(43) Pub. Date: May 16, 2019

(54) METHOD FOR MANUFACTURING A STAMPED MEMBER

(71) Applicant: GM GLOBAL TECHNOLOGY OPERATIONS LLC, Detroit, MI (US)

(72) Inventors: Liang Xi, Northville, MI (US); Xi Yang, Bloomfield Hills, MI (US); Siguang Xu, Rochester Hills, MI (US)

(21) Appl. No.: 15/814,805

(22) Filed: Nov. 16, 2017

(51) Int. Cl. B21D 35/00; H01M 8/0206; H01M 8/1004

(52) U.S. Cl. CPC B21D 35/001; H01M 8/0273; H01M 8/1004; H01M 8/0206

(57) ABSTRACT

A method for manufacturing a stamped member includes the steps of: (1) stamping sheet metal within a stamping press system; (2) assembling the stamped sheet metal with other stamped members to form a plurality of bipolar plates; (3) pre-compressing the first bipolar plate between a pair of flat fixture plates; (4) obtaining first contact pressure variation data; (5) providing a customized patterned fixture which corresponds to the first contact pressure measurement data; (6) pre-compressing the second bipolar plate with the customized patterned fixture; and (7) obtaining second contact pressure variation data.

### TECHNICAL FIELD

The present disclosure generally relates to the manufacture of a stamped product, such as but not limited to, a metallic fuel cell bipolar plate which exhibits dimensional accuracy.

### BACKGROUND

The present invention relates generally to a method for manufacturing a metallic bipolar plate for use in a fuel cell environment that exhibits ease of manufacturability, and more particularly to such a manufacturing method which is easy and inexpensive while preserving the best mechanical/structural properties possible in a bipolar plate.

In many fuel cell systems, hydrogen or a hydrogen-rich gas is supplied through a flow path to the anode side of a fuel cell while oxygen (such as in the form of atmospheric oxygen) is supplied through a separate flow path to the cathode side of the fuel cell. An appropriate catalyst (for example, platinum) is typically disposed to form on these respective sides an anode to facilitate hydrogen oxidation and as a cathode to facilitate oxygen reduction. From this, electric current is produced with water vapor as a reaction by-product. In one form of fuel cell, called the proton exchange membrane or polymer electrolyte membrane (in either event, PEM) fuel cell, an electrolyte in the form of an ionomer membrane is situated between the anode and cathode to form a membrane electrode assembly (MEA) which is further layered between diffusion layers that allow both gaseous reactant flow to and electric current flow from the MEA. The aforementioned catalyst layer may be disposed on or as part of the diffusion layer or the membrane.

To increase electrical output, individual fuel cell units are stacked with bipolar plates disposed between the diffusion layer and anode electrode of one MEA and the diffusion layer and cathode electrode of an adjacent MEA. Typically, the bipolar plates are made from an electrically-conductive material in order to form an electrical pathway between the MEA and an external electric circuit. In such a stacked configuration, the bipolar plates separating adjacently-stacked MEAs have opposing surfaces each of which include flow channels separated from one another by raised lands. The channels act as conduit to convey hydrogen and oxygen reactant streams to the respective anode and cathode of the MEA, while the lands, by virtue of their contact with the electrically conductive diffusion layer that is in turn in electrical communication with current produced at the catalyst sites, act as a transmission path for the electricity generated in the MEA. In this way, current is passed through the bipolar plate and the electrically-conductive diffusion layer.

The interior cells of the stacked assembly comprise one side of each of two opposing bipolar plates. The facing bipolar plates enclose cell elements comprising a proton exchange membrane-electrode assembly, gaskets, gas diffusion media, and the like. Each bipolar plate is formed of two like-shaped plates, in face-to-face arrangement, that have gas flow passages on their external faces and internal coolant passages defined by their inverse and facing sides. As shown in the example bipolar plate of FIG. 1, one side of a first bipolar plate provides passages for the flow of hydrogen to the anode side of the membrane-electrode assembly and one side of a second, opposing bipolar plate provides passages for the flow of air to the cathode side of the membrane-electrode assembly. Heat is produced in the operation of the stack of cells and coolant flow through the interior of the bipolar plates is used to cool the stack, particularly the internal cells of the stack.

A bipolar plate is typically stamped from a thin, generally rectangular sheet of metal and, preferably, each sheet is of generally the same shape. Opposing edges at the short sides of each rectangular sheet are shaped apertures, respectively, for the inlet and exit of fuel, oxidant, and coolant. The central portion of each sheet is shaped with spreading flow channels for gas flow from the inlet, channels for distributed flow of gas over the membrane, and converging channels for directing gas to the exit. When two such sheets are suitably bonded with gas flow passages facing outwardly to form a bipolar plate, the inverse sides of the stamped sheets provide flow-controlling passages for the coolant. In the assembly of a fuel cell stack each bipolar plate is intended to form a part of two adjacent cells, one cell on each outer face of the bipolar plate. One outer face of a bipolar plate provides an anode plate for one cell and the other outer face provides a cathode plate for the adjacent cell.

Because the bipolar plate operates in a high temperature and corrosive environment, conventional metals, such as plain carbon steel, may not be suitable for certain applications (such as in automotive environments) where long life (for example, about 10 years with 6000 hours of life) is required. During typical PEM fuel cell stack operation, the proton exchange membranes are at a temperature in the range of between about 75° C. and about 175° C., and at a pressure in the range of between about 100 kPa and 200 kPa absolute. Under such conditions, plates made from alloyed metals such as stainless steel may be advantageous, as they have desirable corrosion-resistant properties. In situations where cost of fuel cell manufacture is an important consideration, metal-based bipolar plates may be preferable to other high-temperature, electrically conductive materials, such as graphite. In addition to being relatively inexpensive, stainless steel plates can be formed from relatively thin sheet metal (for example, between 0.05 and 1.0 millimeters in thickness).

Given the detailed features (flow channels and metal bead seals) which must be manufactured into a bipolar plate, current bipolar plate manufacturing accounts for high portion of overall fuel cell stack cost. Mile using stamped stainless steel bipolar plates would be beneficial in addressing a significant portion of this cost, the low formability of stainless steel in general is a significant challenge in producing bipolar plates. This challenge occurs due to the fact that the manufacturing process involves stamping very thin (for example, 0.100 millimeters or thinner) sheets which must possess the required channel strength and depth to satisfy functional requirements.

The stack, which can contain more than one hundred plates, is compressed, and the elements held together by bolts through corners of the stack and anchored to frames at the ends of the stack. In order to militate against undesirable leakage of fluids from between the pairs of plates, a seal is often used. The seal is disposed along a peripheral edge of the pairs of plates. Prior art seals have included the use of an elastomeric material in conjunction with a bead stamped into the bipolar plate.

It would be desirable to produce a metal bead seal for sealing between plates of a fuel cell system, wherein the bead structure militates against a leakage of fluids from the fuel cell system and a cost thereof is minimized

It is further understood that the contact pressure between the metal bead seals of the bipolar plates in a fuel cell stack may vary in an undesirable manner due to the stiffness at different regions of the plate. The varied contact pressure at different locations in the bipolar plates is not desirable given that it negatively affects the efficiency of the fuel cell stack. The stiffness may vary at different regions in the bipolar plates due to the configuration of the metal bead seals in the different regions in the bipolar plates. For example, where the metal bead seal curves (“collared regions”) the walls of the metal bead seal tend to be rather stiff relative to the regions where the metal bead seal is substantially straight (“straight regions”). Therefore, regions where the stiffness in the metal bead seal is relatively high, the contact pressure between the bipolar plates is relatively higher than other regions where the stiffness in the metal bead seal is lower.

The above information disclosed in this Background section is only for enhancement of understanding of the background of the invention, and therefore, it may contain information that does not form the prior art that is already known in this country to a person of ordinary skill in the art. Accordingly, there is a need for a manufacturing method which is cost-effective, time efficient and could produce bipolar plates having improved dimensional accuracy while also providing substantially even contact pressure over the entire bipolar plate.

### SUMMARY

The present disclosure provides a method for manufacturing a stamped member which includes the steps of: (1) stamping a piece of sheet metal within a stamping press system forming a plurality of stamped members; (2) assembling the plurality of stamped members to form a bipolar plate; (3) pre-compressing a first bipolar plate between a pair of flat fixture plates; (4) obtaining first contact pressure variation data; (5) providing a customized patterned fixture which corresponds to the first contact pressure measurement data; (6) compressing a second bipolar plate with the customized patterned fixture; and (7) obtaining second contact pressure variation data.

It is understood that the step of stamping the piece of sheet metal may include stamping the piece of sheet metal with at least one die to define a flat land, a first sidewall, a second sidewall and a first bead depth for at least one metal bead seal. The stamped sheet metal may then be assembled with another stamped sheet metal member to form a bipolar plate with metal bead seals. The metal bead seal may be pre-compressed between a pair of flat dies in order to reduce metal bead and microseal tolerances due to manufacturing.

To the extent excessively high pressure regions and excessively low pressure regions are identified on the pressure measurement film—resulting in significant pressure variations, a customized patterned fixture is provided where embossment(s) are defined in the high pressure regions thereby reducing the height of the metal bead seal(s). The reduced height of the bead seal(s) accordingly reduces the high contact pressure in the identified high pressure region. Similarly, pressure measurements may or may not identify at least one low pressure region on the stamped product or bipolar plate. Accordingly, the customized patterned fixture should also include recesses or slots which correspond to the low pressure regions such that the customized patterned fixture will not further deform the low pressure metal bead region. It is understood that where the pressure measurements shows normal contact pressure in specific regions, the customized pattern fixture is flat such that neither a recess nor an embossment is implemented in normal contact regions.

Once all of the embossments and/or recesses are defined in the first customized patterned fixture based on the first pressure measurement data, the stamped sheet metal may then be pre-compressed by the customized patterned fixture which deforms the high pressure metal bead region(s) such that the height(s) are reduced thereby reducing contact pressure variation across the various areas of the metal bead seal. After the metal bead seal is pre-compressed by the customized patterned fixture, a second measurement is taken where contact pressure is measured over the metal bead seals. In the event that pressure variation across the sheet metal/bipolar plate falls within acceptable limits, then the customized patterned fixture may be implemented for use in mass production. However, in the event pressure variation across the sheet metal/bipolar plate falls outside the scope of acceptable limits (pressure variation is too high), then the customized patterned fixture design may be modified to; (1) add additional embossments in regions or increase the size of existing embossments in regions which still exhibit high levels of contact pressure; (2) add additional recesses or increase the size of recesses in regions which still exhibit low levels of contact pressure; (3) remove or reduce embossments in low pressure regions; and/or (4) remove or reduce recesses high pressure regions.

If implemented, the modified customized patterned fixture then pre-compress a third stamped product or a third bipolar plate from the plurality of stamped products/bipolar plates to further reduce the contact pressure variation across the bipolar plate/stamped product to acceptable levels. Similarly, contact pressure measurements are again taken across the third bipolar plate/stamped product as previously described. In the event that pressure variation across the third stamped product/bipolar plate falls within acceptable limits, then the modified customized patterned fixture may be implemented for use in mass production. However, in the event pressure variation across the third stamped product/bipolar plate falls outside the scope of acceptable limits (pressure variation is too high), then modified customized patterned fixture is revised again as previously described until contact pressure variation across the bipolar plate/stamped sheet metal falls within acceptable limits,

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 illustrates an example stamped member wherein the stamped product is in the form of a bipolar plate.

FIG. 2 flowchart of an example, non-limiting manufacturing method of the present disclosure.

FIG. 3 illustrates a schematic flat pre-compression fixture.

FIG. 4 illustrates an example, non-limiting schematic patterned fixture having one embossment.

FIG. 5 illustrates an example, non-limiting schematic patterned fixture having one recess.

FIG. 6 illustrates an example, non-limiting schematic patterned fixture having both an embossment and a recess.

FIG. 7 illustrates a flow chart of an example process for providing a patterned fixture based on contact pressure measurements from a stamped member or bipolar plate.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any manner.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

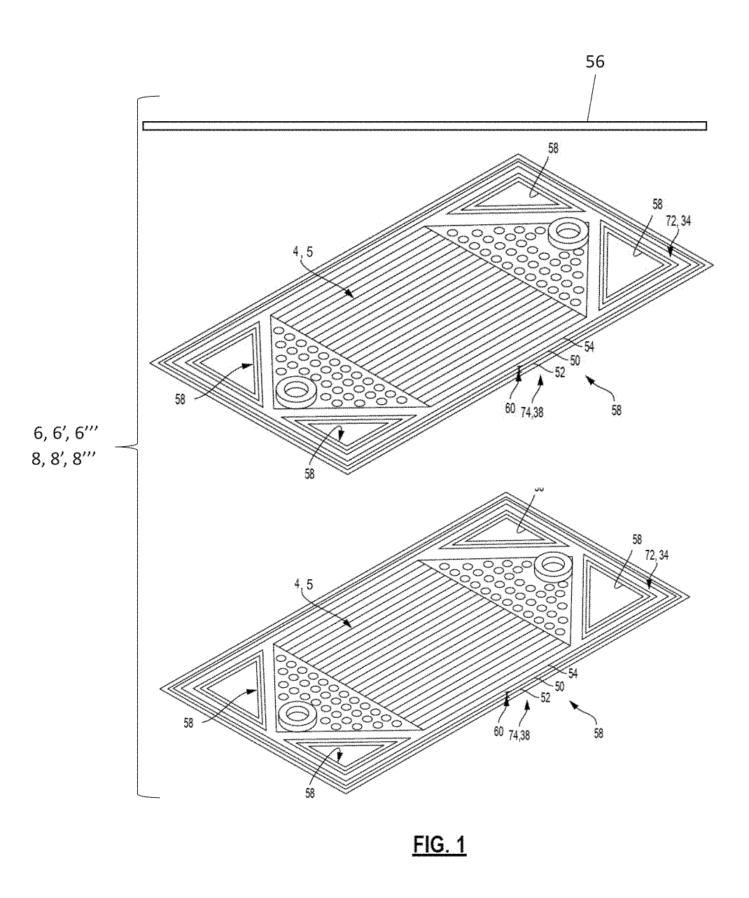

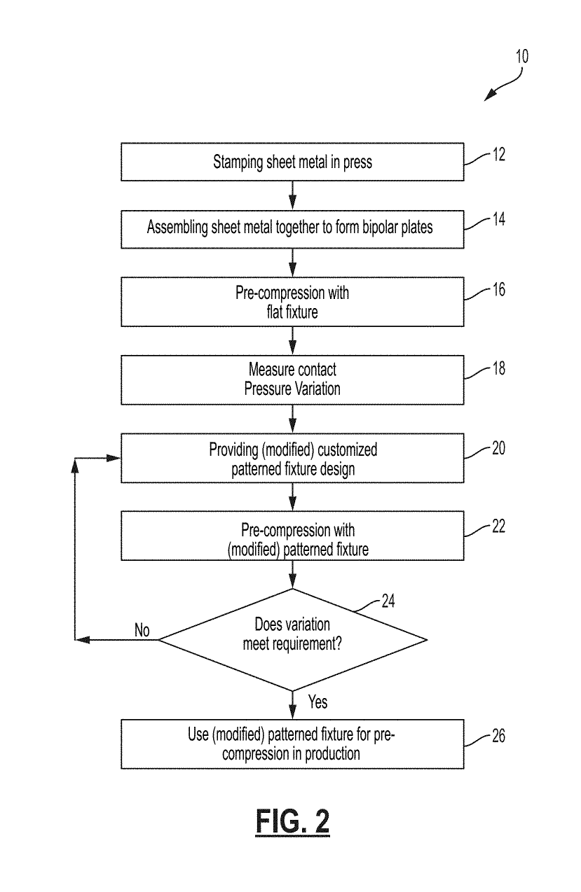

With reference to FIG. 2, a flowchart is provided which shows an example non-limiting method 10 of the present disclosure. As shown, the method 10 for manufacturing a bipolar plate 6 (shown in FIG. 1) (or stamped product 4) includes the steps of: (1) stamping a piece of sheet metal 8 within a stamping press system to form a plurality of stamped members; 12 (2) assembling the plurality of stamped members to form a plurality of bipolar plates; step 14 (2) pre-compressing a first bipolar plate between a pair of flat fixture plates; 16 (3) obtaining first contact pressure variation data of at least two metal bead regions 72, 74; 18 (4) providing a customized patterned fixture 28 which corresponds to the first contact pressure variation data; 20 (5) pre-compressing a second bipolar plate with the customized patterned fixture 28; 22 and (6) obtaining second contact pressure variation data of the at least two metal bead regions 72, 74 stamped in the second bipolar plate 6′ or stamped product 4′ to determine if contact pressure variation between the at least two metal bead regions 72, 74 of the second bipolar plate has been reduced. 24

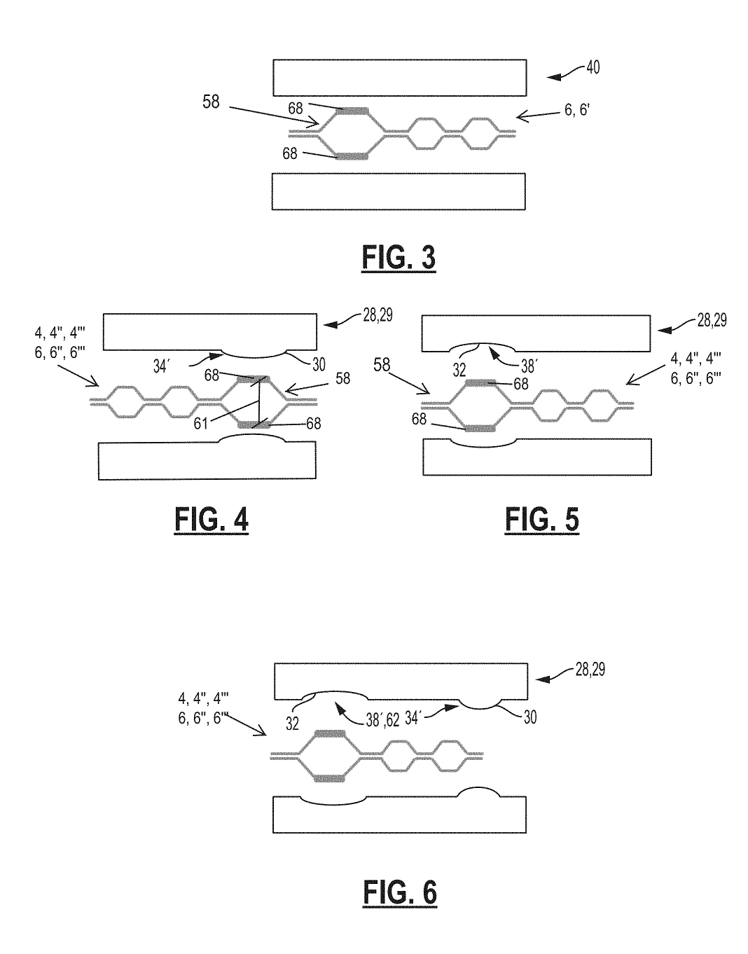

It is understood that the step (element 14 in FIG. 2) of stamping the piece of sheet metal 8 may include stamping the piece of sheet metal 8 with at least one die to define a flat land 50, a first sidewall 52, a second sidewall 54 and a first/second sidewall depth/height (element 60 in FIG. 1) for at least one metal bead 58. The step of stamping sheet metal 8 to form the metal bead 58 in each stamped sheet 5 results in the formation of a plurality of stamped members 5, the stamped members 5 or sheet metal 8 may be assembled together to form a plurality of bipolar plates 8 or stamped products 4. A first bipolar plate 6 may then be pre-compressed between a pair of flat dies (element 40 shown in FIG. 3) in order to reduce metal bead 58 and microseal 68 tolerances due to manufacturing. Pre-compression between the flat dies 40 also may reduce creep variation of softgoods such as the subgasket, microseal and adhesive. Pre-compression also enforces the metal bead 58 such that the metal bead 58 will tend to behave elastically. Moreover, pre-compression also enables easy calculation of the stack load and set-up given that the mechanical behavior of the entire stack of bipolar plates 6 is stabilized after undergoing pre-compression.

As shown in FIG. 2, the step 18 of obtaining the first contact pressure variation data between at least two metal bead regions 72, 74 (FIG. 1) in the first bipolar plate 6 may, but not necessarily, implement the use of a pressure measurement film 56 (FIG. 1) such as, but not limited to Fuji® film. In one non-limiting example, the pressure measurement film 56 (FIG. 1) may be disposed between the bipolar plate 6 and two flat compression plates which exert pressure on the bipolar plate 6 and the pressure measurement film 56 (FIG. 1). The pressure measurement film 56 (FIG. 1) may include one layer of micro-encapsulated color forming material and another layer of color-developing material. Thus, when pressure is applied, the microcapsules are broken such that color forming material reacts with the color developing material causing colored patches to form on the film in high pressure regions 34—such as certain metal bead regions 72, 74.

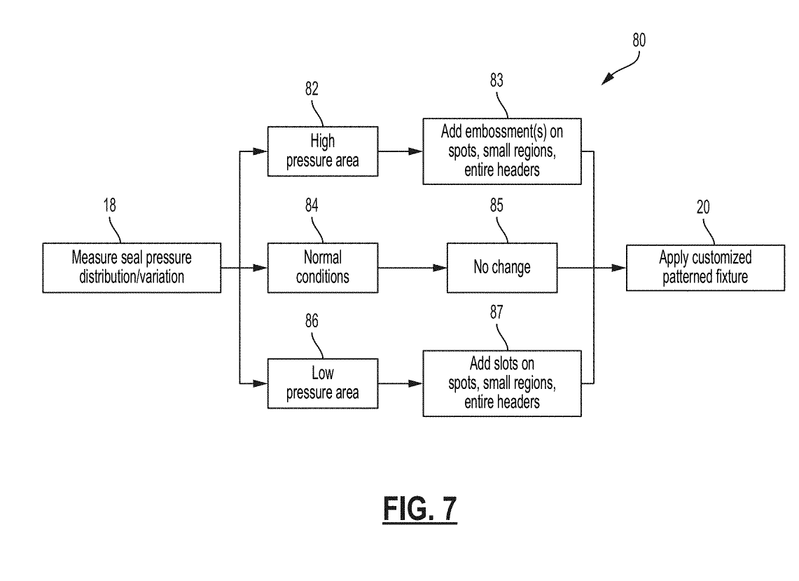

With reference to FIG. 7, the process 80 of correlating the pressure measurements to a customized patterned fixture 28 is illustrated in a flow chart. In one example pressure measurement test which uses pressure measurement film 56 (FIG. 1), the level/amount of color exposed at different regions of the bipolar plate 6 (or stamped product 4) (through the use of pressure measurement film 56 (FIG. 1)) may identify any contact pressure variations across the surface of the bipolar plate 6, 6′ (or stamped product 4). To the extent excessively high pressure regions 34 (FIG. 1) and excessively low pressure region 38 (FIG. 1) are identified in the plate 6, 6′ or stamped product 4 (element 82 in FIG. 7) via the pressure measurement film 56 (FIG. 1)—resulting in significant pressure variations, a customized patterned fixture 28 (FIGS. 4, 6) is provided where embossment(s) 30 are defined in the high pressure regions 34′ of the fixture (FIG. 4) which correspond to high pressure regions 34 found in the plate 6 or stamped product 4 (FIG. 1) such that the added embossment(s) 30 compress metal bead(s) 58 more thereby reducing the height 61 (FIG. 4) of the metal bead(s) 58. The reduced height 61 of the beads 58 accordingly reduces the contact pressure in the identified high pressure region 34. Similarly, the pressure measurement film regions with little to no color exposed (after compression) may identify (element 86 in FIG. 7) at least one low pressure region (example element 38 in FIG. 1) on the bipolar plate 6, 6′ or stamped product 4. Accordingly, the customized patterned fixture 28, 29 should also include recesses 32 or slots in region(s) 38′ of the customized patterned fixture 28, 29 which correspond to the low pressure regions 38 such that the customized patterned fixture 28, 29 will not further deform the low pressure metal bead region 38. It is understood that where the pressure measurement film shows normal contact pressure in specific regions (via the amount of color exposed in the chosen film (step 84 in FIG. 7), the customized pattern fixture 28 is flat (element 85 in FIG. 7) such that neither a recess nor an embossment is implemented in normal contact pressure regions,

Referring back to FIG. 2, once all of the embossments 30 and/or recesses 32 are defined in the customized patterned fixture 28, a second bipolar plate 6′ may be pre-compressed by the customized patterned fixture 28 which deforms the high pressure metal bead region(s) 34 such that the height(s) (example element 61 in FIG. 4) are reduced and which does not further deform the low pressure metal bead region(s) 38 thereby reducing contact pressure variation across the various areas of the stamped product 4 or second bipolar plate 6′. After the stamped product 4′ or bipolar plate 6′ has been pre-compressed by the customized patterned fixture 28, a second measurement (element 24 in FIG. 2) is taken where contact pressure is measured over the various regions of the second stamped product 4′ or bipolar plate 6′. In the event that pressure variation across the stamped product 8/bipolar plate 6 falls within acceptable limits, then the customized patterned fixture 28 may be implemented for use in mass production. (Element 26 in FIG. 2)

However, in the event pressure variation across the second stamped product 4′ or second bipolar plate 6′ falls outside the scope of acceptable limits (pressure variation is too high), then the customized patterned fixture 28 design may be modified to: (1) add additional embossments 30 in remaining high pressure regions 34 or increase the size of existing embossments 30 in regions 34 which still exhibit high levels of contact pressure; (element 83 in FIG. 7) (2) add additional recesses 32 or increase the size of recesses 32 in regions 38 which still exhibit low levels of contact pressure; (element 87 in FIG, 7).

Referring back to FIG. 1, the modified customized patterned fixture 29 then pre-compresses a third bipolar plate 6′″ (or third stamped product 4′″)—to further reduce the contact pressure variation across the bipolar plate 6′″/stamped product 4′″ so that the variation falls within a pre-determined (acceptable) range. Similarly, contact pressure measurements are again taken across the bipolar plate 6′″/stamped product 4′″ as previously described. In the event that pressure variation across the bipolar plate 6′″/stamped product 4′″ falls within an acceptable predetermined range, then the modified customized patterned fixture 29 may be implemented for use in mass production. However, in the event pressure variation across the bipolar plate 6′″/stamped product 4′″ falls outside the scope of acceptable predetermined range (pressure variation is too high), then modified customized patterned fixture 29 is revised again as previously described until contact pressure variation across the bipolar plate 6/stamped sheet metal 8 falls within acceptable limits.

Accordingly, the customized patterned fixture 28 includes at least one of an embossment 30 or a recess 32 (or both) which corresponds to data derived from the first contact pressure measurement. Similarly, the modified customized patterned fixture 29 (if needed) includes at least one embossment 30 or recess 32 as previously described which corresponds to the second contact pressure variation data when the contact pressure variation of the second bipolar plate 6″ or second stamped product 4″ has not been reduced via the initial stamping with the customized patterned fixture 28. As noted, the (modified) customized patterned fixture 28, 29 which tunes the bipolar plates 6 or second stamped products 4 to fall within acceptable contact pressure variation limits is configured for later use in mass production.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for manufacturing a bipolar plate comprising the steps of:
stamping sheet metal within a stamping press system to form a plurality of stamped members;
assembling the plurality of stamped members to form a plurality of bipolar plates; and
pre-compressing the bipolar plate between a pair of flat fixture plates;
obtaining first contact pressure variation data of at least two metal bead regions stamped in the bipolar plate;
providing a customized patterned fixture which corresponds to the first contact pressure variation data;
pre-compressing the a second bipolar plate with the customized patterned fixture; and
obtaining second contact pressure variation data of the at least two metal bead regions stamped in the second bipolar plate to determine if contact pressure variation between the at least two metal bead regions has been reduced.

2. The method for manufacturing a bipolar plate as defined in claim 1 further comprising the step of providing a modified customized patterned fixture device which corresponds to the second contact pressure variation data when the contact pressure variation of the bipolar plate falls outside of a pre-determined range.

3. The method for manufacturing a bipolar plate as defined in claim 1 wherein the steps of obtaining first and second contact pressure variation data implements a pressure measurement film.

4. The method for manufacturing a bipolar plate as defined in claim 1 wherein the customized patterned fixture includes at least one of an embossment or a recess which corresponds to the first contact pressure variation data.

5. The method for manufacturing a bipolar plate as defined in claim 4 where an embossment is defined in the customized patterned fixture in a high pressure region.

6. The method for manufacturing a bipolar plate as defined in claim 4 where a recess is defined in the customized patterned fixture in a low pressure region.

7. The method for manufacturing a bipolar plate as defined in claim 4 wherein the customized patterned fixture is configured for use in mass production.

8. A method for manufacturing a stamped product comprising the steps of:
stamping sheet metal within a stamping press system and forming a plurality of stamped members;
assembling the plurality of formed members to form a plurality of stamped products;
pre-compressing a first stamped product between a pair of flat fixture plates;
obtaining first contact pressure variation data of at least two metal bead regions stamped in the first stamped product;
providing a customized patterned fixture which corresponds to the first contact pressure variation data;
pre-compressing a second stamped product with the customized patterned fixture; and
obtaining second contact pressure variation data of at least two metal bead regions in the second stamped product to determine if contact pressure variation between the at least two metal bead regions has been reduced.

9. The method for manufacturing a stamped product as defined in claim 8 further comprising the step of providing a modified customized patterned fixture device which corresponds to the second contact pressure variation data when the contact pressure variation of the first stamped product has not been reduced to acceptable levels

10. The method for manufacturing a stamped product as defined in claim 8 wherein the steps of obtaining first and second contact pressure variation data implements a pressure measurement film.

11. The method for manufacturing a stamped product as defined in claim 8 wherein the customized patterned fixture includes at least one of an embossment or a recess which corresponds to the first contact pressure measurement data.

12. The method for manufacturing a stamped product as defined in claim 10 where an embossment is defined in the customized patterned fixture in a high pressure region.

13. The method for manufacturing a stamped product as defined in claim 10 where a recess is defined in the customized patterned fixture in a low pressure region.

14. The method for manufacturing a stamped product as defined in claim 8 wherein the customized patterned fixture is configured for use in mass production.

15. The method for manufacturing a stamped product as defined in claim 8 wherein the customized patterned fixture is configured for use in mass production.
